(19) United States
(12) Patent Application Publication
(10) Pub. No.: US 2010/0076741 A1
(43) Pub. Date: Mar. 25, 2010

(54) SYSTEM, METHOD AND PROGRAM FOR DETERMINING WORST CONDITION OF CIRCUIT OPERATION

(76) Inventor: Kiyoshi Takeuchi, Tokyo (JP)

Correspondence Address: Mr. Jackson Chen, 6535 N. STATE HWY 161, IRVING, TX, 75039, US

(21) Appl. No.: 12/527,862

(22) PCT Filed: Feb. 13, 2008
(86) PCT No.: PCT/JP2008/052363

§ 371 Date: Aug. 19, 2009

(30) Foreign Application Priority Data
Feb. 19, 2007 (JP) 2007-037954

(51) Int. Cl. G06F 17/50; G06F 17/18

(52) U.S. Cl. 703/14; 702/181

(57) ABSTRACT

A system for determining a worst condition, wherein, in a model for which one or more parameters included in a model function that simulates a circuit performance index are random variable(s) to simulate the circuit performance index and fluctuations thereof, the parameter(s) for which the circuit performance index assumes a maximum or minimum value that is to be assumed from the viewpoint of designing is determined as the worst condition; the system comprises a worst condition search unit that searches for a point, having a maximum or minimum value of the circuit performance index, on an equi-probability surface corresponding to a preset good product ration within a space defined by the parameter(s); the point thus searched being determined as the worst condition.

This application is the National Phase of PCT/JP2008/052363, filed Feb. 13, 2008 which is based upon and claims priority to Japanese Patent Application 2007-037954, filed Feb. 19, 2007. The contents of which are incorporated by reference in its entirety.

### TECHNICAL FIELD

This invention relates to a system, a method and a program for determining a worst condition of the circuit operation. More particularly, it relates to a system, a method and a program for determining a worst condition by which the worst condition needed in designing an integrated circuit device may be drawn out in case characteristics of components of the integrated circuit device suffer from statistical fluctuations.

### BACKGROUND ART

In designing an integrated circuit, circuit simulation is used. In the circuit simulation, characteristics of devices, such as transistors, that compose a circuit, are expressed by simple model equations. Using these model equations, even complicated circuits may be simulated in a short time. An integrated circuit needs to be designed by taking statistical fluctuations of device characteristics into consideration, in such a manner that, even if the device characteristics are statistically deviated to some extent from the typical values, the circuit will be in regular operation.

To take fluctuations in device characteristics into consideration, such a method that takes the worst conditions into consideration is generally used. For example, suppose that the threshold value Vth of a MOS transistor is fluctuated in a range from Vth1 to Vth2 due to manufacturing tolerances. Then, if a simulated circuit is in regular operation no matter which of a transistor model corresponding to the lowest Vth1, referred to below as a ‘Fast’ model, or a transistor model corresponding to the highest Vth1, referred to below as a ‘Slow’ model, is used, it is confirmed that the circuit has been correctly designed. If the worst conditions are known, it is sufficient to verify the circuit operation only under these conditions, and it is unnecessary to verify that the circuit will be in regular operation under numerous other conditions.

If fluctuations are mainly caused by non-uniformities of manufacturing equipments, the characteristics of all the transistors in the integrated circuit are deviated in the same direction. In such cases, the condition where all the transistors are Slow, and the condition where all the transistors are Fast, may be regarded as the worst conditions. The Fast and Slow models can be easily determined, since it is sufficient to focus attention on the fluctuations of the characteristics (eg. Threshold voltage Vth) of a sole transistor as representative of all the transistors in the integrated circuit. The boundaries of a region, in which a characteristic value falls with a sufficiently high probability, may then be determined as the Fast and Slow conditions.

However, due to miniaturization of transistors in these days, such tendency in which characteristics of a plurality of transistors are not fluctuated in unison, but characteristics of individual transistors are fluctuated at random, has become important. If random fluctuations are significant, it becomes difficult to determine the worst condition. For example, it is assumed that N transistors (N is a number) are included in a circuit, and the threshold values Vth of respective transistors are fluctuated at random. It is then highly likely that respective transistors undergo Vth deviations in separate ways. Hence, in the situation where a certain circuit characteristic value becomes worst, the Vth deviations may differ from one of the N transistors to another.

In such cases, a method is needed which can find out the correct worst condition out of various possible combinations of Vth deviations. The worst conditions may differ from one circuit type to another.

As a method to find out the worst conditions when random fluctuations exist, there has been known a Monte Carlo method. For example, in the above case, Vth values of the N transistors are set at random, in accordance with respective preset probability density functions, and a characteristic value of a circuit is calculated. These stochastic trial operations are repeated a sufficiently large number of times, and the distribution of the resulting characteristic values of the circuit is checked. If the distribution can be regarded as a normal distribution, the standard deviation σ is calculated, and a trial condition that has resulted in a characteristic value offset by, for example, 3σ from the average value is adopted as the worst condition.

Patent Document 1 shows a method that considers a set of a plurality of circuit performance indexes and that defines the combination of process parameters that varies the indexes most significantly as the worst condition. This worst condition is determined by analyzing the sensitivity of the performance indexes to the parameters.

Patent Document 2 and Non-Patent Document 1 show a method that automatically searches for circuit constants in order to provide for a maximum circuit yield without using the Monte Carlo method.

### Patent Document 1:

JP patent Kokai Publication No. JP2001-195445A

### Patent Document 2:

JP patent Kokai JP-H6-139303A

### Non-Patent Document 1:

K. K. Low et al., “A New Methodology for the Design Centering of IC Fabrication Process”, IEEE Transactions on Computer-Aided Design, vol. 10 (1991)

### SUMMARY

The disclosures of the above Patent Documents 1, 2 and Non-Patent Document 1 are incorporated herein by reference thereto. The following is an analysis of the related techniques by the present invention.

As a method for calculating the worst condition when random fluctuations exist, there has been known a Monte Carlo method. If the worst condition is to be determined with the use of the Monte Carlo method, a large number of trial operations need to be carried out. If the distribution of a characteristic value obtained is a normal distribution, at least 300 trial operations are desirably carried out to determine the standard deviation σ, because the Monte Carlo method is a stochastic method and hence the results of the trial operations may be subject to offsets. To assure that the offset is sufficiently small, the number of trial operations needs to be increased, thus leading to time-consuming calculations.

In particular, if the response of the characteristic circuit value to the random variables is non-linear, the problem becomes more serious. In this case, even granting that the distributions of the parameters varied with the Monte Carlo method are normal, the distribution of the characteristic circuit value is not normal. Hence, the worst condition cannot be derived if simply σ is determined, and a larger number of calculations are needed. Let us consider the circuit of a memory cell, for example. Since an extremely large number of, such as one million, memory cells are integrated to form the memory circuit, the good (non-defective) product ratio of each memory cell needs to be extremely high, such as 0.1 ppm [of defective ratio], to provide for a non-defective memory circuit. To determine the worst condition for such very low defective product ratio, an extremely large number of trial operations are needed in order for an event of extremely low frequency of occurrence to be included within the trial operations. For example, if 100 events each with an occurrence probability of 0.1 ppm are to occur, one billion trial operations are needed. Since it is not realistic to carry out such a large number of trial operations at the stage of designing, there is placed a limitation to the Monte Carlo method.

Patent Document 1 discloses a method of finding out the direction of a parameter vector that drastically varies the performance index by sensitivity analysis without relying upon the

Monte Carlo method. The parameter vector is a vector having a set of parameters as an element. However, the worst condition is desirably determined in response to a desired good product ratio, that is, as a function of the good product ratio. However, in Patent Document 1, there is not disclosed a method for correlating the desired good product ratio with the parameter vector. Moreover, since the sensitivity analysis is based on linear approximation, there is fear that sufficient accuracy cannot be realized in case there exists a non-linear relationship between the performance index and the parameters.

In Patent Document 2 and Non-Patent Document 1, there is disclosed a method for automatically searching for the design condition that provides for a highest probability of satisfying the entire of constraint conditions with respect to the performance indexes of an integrated circuit. However, there is not disclosed a guideline for determining those constraint conditions. In particular, there is not disclosed a technique that determines the constraint condition that will give a desired yield (good product ratio).

It is thus incumbent on the present invention to provide a means for determining the worst condition that is able to determine the worst condition corresponding to the desired good product ratio, in a shorter time than with the Monte Carlo method, in case characteristics of devices included in the circuit suffer from random fluctuations.

In one aspect, the present invention provides a system for determining a worst condition, wherein, in a model for which one or more parameters included in a model function that simulates a circuit performance index are random variable(s) to simulate the circuit performance index and fluctuations thereof, the parameter(s) for which the circuit performance index has a maximum or minimum value that is to be assumed from the viewpoint of designing is determined as the worst condition. The system comprises a worst condition search unit that searches for a point, which maximizes or minimizes the circuit performance index, on an equi-probability surface or in a region surrounded by the equi-probability surface in a space spanned by the parameter(s). The equi-performance surface corresponds to a preset good (i.e. non-defective) product ratio. The point thus obtained is determined as the worst condition.

The system for determining a worst condition in a first mode of the first aspect of the present invention further comprises an inputting unit that inputs the information that specifies the good product ratio used in the worst condition search unit, a performance index calculation unit that calculates the circuit performance index based on the model function, and an outputting unit that outputs the worst condition as found by the worst condition search means.

In a second aspect, the present invention provides a system for determining a worst condition, wherein, given a model function of a performance index and a probability density function for a set of variable(s) of the model function, a point, on an equi-value surface of the model function having the highest occurrence probability, is determined as the worst condition on condition that the probability density function integrated over a subdomain of definition corresponding to better performance index, bounded by the equi-value surface of the model function is equal to a preset value. The system comprises a worst condition search unit. The worst condition search unit determines an equi-probability surface that is to be tangent to said equi-value surface. The worst condition search unit searches for a point which maximizes or minimizes the performance index on the equi-probability surface or within a region surrounded by the equi-probability surface, and determines the point as the worst condition.

In a third aspect, the present invention provides a method for determining a worst condition, wherein, in a model for which one or more parameters included in a model function that simulates a circuit performance index are random variable(s) to simulate the circuit performance index and fluctuations thereof, the parameter for which the circuit performance index assumes a maximum or minimum value that is to be assumed from the viewpoint of designing is determined as the worst condition. The method comprises determining an equi-probability surface corresponding to a preset good product ratio in a space spanned by the parameter(s), and searching for a point, which maximize or minimize the performance index, on the equi-probability surface or within a region surrounded by the equi-probability surface. The worst condition search means sets the point as the worst condition.

In a fourth aspect, the present invention provides a program that causes a computer to perform a processing, wherein, in a model for which one or more parameters included in a model function that simulates a circuit performance index are random variable(s) to simulate the circuit performance index and fluctuations thereof, the parameter(s) for which the circuit performance index assumes a maximum or minimum value that is to be assumed from the viewpoint of designing is determined as the worst condition. The program causes the computer to perform: determining an equi-probability surface corresponding to a preset good product ratio in a space spanned by the parameter(s), and searching for a point which maximizes or minimizes the performance index, on the equi-probability surface or within a region surrounded by the equi-probability surface. The point as searched is determined as the worst condition.

With the system for determining a worst condition in a second mode according to the present invention, the equi-probability surface is one of a hyper-ellipsoidal surface, an ellipsoidal surface and an arc of ellipse.

With the system for determining a worst condition in a third mode according to the present invention, the outputting unit is adapted to further output that the worst condition as found by the worst condition search unit existed inside of the equi-probability surface.

With the system for determining a worst condition in a fourth mode according to the present invention, the model function is calculated by circuit simulation.

With the system for determining a worst condition in a fifth mode according to the present invention, the model function is a response surface function.

According to the present invention, it is possible to determine the worst condition of a circuit in case there are random fluctuations of characteristics.

Also, according to the present invention, in case there are random fluctuations of characteristics, the worst condition determined may be used to check whether or not a circuit design that yields a desired good product ratio has been realized.

Moreover, according to the present invention, since the problem of determining the worst condition of the circuit reduces to the problem of extremum search with constraint conditions, the worst condition can be determined expeditiously for a smaller computational cost than with the Monte Carlo method.

### BRIEF DESCRIPTION OF THE DRAWINGS

FIG. 1 is a block diagram showing a worst condition determining system according to an exemplary embodiment of the present invention.

FIG. 2 is a circuit diagram of an SRAM for illustrating the operation of the worst condition determining system according to the exemplary embodiment of the present invention.

FIG. 3 is a graph for illustrating the operation of circuit simulation for the SRAM of FIG. 2.

FIGS. 4A and 4B are graphs for illustrating the transformation of random variables.

FIG. 5 is a graph for illustrating the relationship between the worst performance index and the good product ratio.

FIG. 6 is a graph for illustrating the relationship between the equi-performance surface and the good product ratio.

FIG. 7 is a flowchart for illustrating the method for determining the worst condition according to the exemplary embodiment of the present invention.

FIG. 8 is a graph showing an example of the worst condition as obtained with the method for determining the worst condition according to the exemplary embodiment of the present invention.

### EXPLANATIONS OF SYMBOLS

100 worst condition determining system
101 worst condition determining unit
102 inputting unit
103 outputting unit
111 worst condition searching unit
112 performance index calculation unit

### PREFERRED MODES

Referring to the drawings, an exemplary embodiment of the present invention will be described in detail.

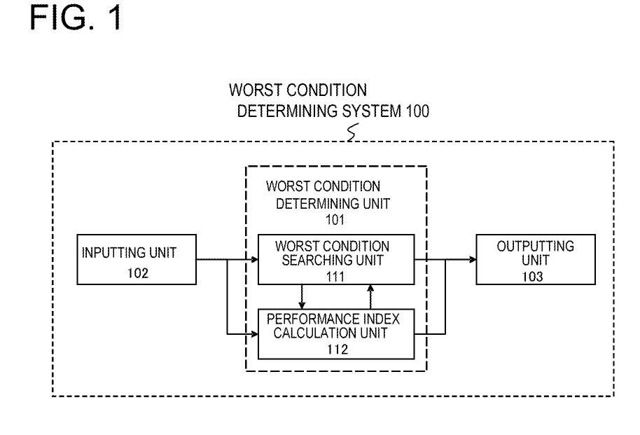

FIG. 1 depicts a block diagram showing a worst condition determining system 100 according to an exemplary embodiment of the present invention. The worst condition determining system 100 includes a worst condition determining unit 101.

The worst condition determining unit 101 includes a worst condition searching unit 111 and a performance index calculation unit 112.

The performance index calculation unit 112 calculates the performance index using a model. The model simulates a circuit performance index and fluctuations thereof, wherein the fluctuations are simulated by regarding one or more parameters included in the model as random (probability) variable(s).

The worst condition searching unit 111 inputs a set of values of parameters, which are to be random variables, to the performance index calculation unit 112. The performance index calculation unit 112 calculates a performance index value, which corresponds to the input, to return the result to the worst condition searching unit 111. The worst condition searching unit 111 iteratively performs this sequence of operations to determine the worst condition. That is, the worst condition searching unit 111 executes the search using the performance index calculation unit 112.

The worst condition determining system 100 may further include an inputting unit 102 and an outputting unit 103.

The inputting unit 102 acquires the information it needs from a file on a memory or from an inputting device. Examples of the information include the model formulation, conditions for calculating the model, a desired good product ratio and other conditions for deriving the worst condition, such as power supply voltage or input waveforms. The model formulation may be exemplified by a net list stating a constitution of a circuit for circuit simulation and parameters of a transistor model for circuit simulation.

The outputting unit 103 outputs the derived results to a file on the memory or to the outputting device.

The worst condition determining system 100 of the exemplary embodiment of the present invention may further include a means that executes circuit simulation using the worst condition as obtained. The worst condition determining system 100 may further include a means that draws out a response surface which will be explained subsequently.

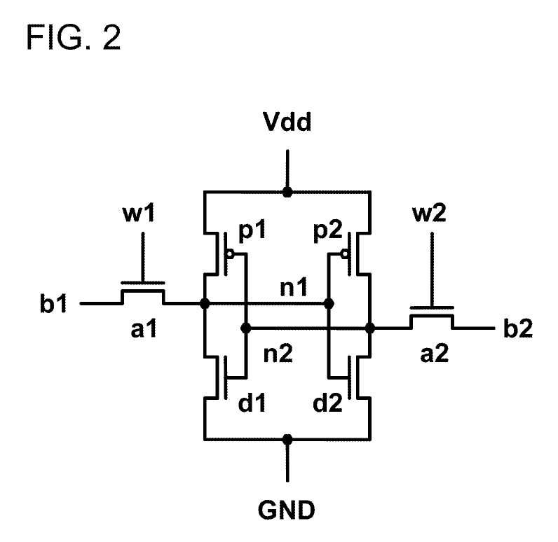

To assist in understanding, a specific example is now described. FIG. 2 depicts a circuit diagram of a memory cell that composes a conventional SRAM (Static Random Access memory). The memory cell is made up of driver transistors d1, d2, access transistors a1, a2 and load transistors p1, p2, totaling at six transistors. As an example, the driver transistors d1, d2 and the access transistors a1, a2 may be n-channel MOSFETs and the load transistors p1, p2 may be p-channel MOSFETs. The transistors a1, a2 have gates w1, w2 connected to a common word line, the access transistor a1 has one terminal b1 connected to a first bit line and the access transistor a2 has one terminal b2 connected to a second bit line. The memory cell is also connected to a power supply Vdd and to the ground GND (zero potential). If one of inner nodes n1 and n2 of the memory is at a power supply potential, the other inner node is at the ground potential, so that the information of 1 and 0 is stored depending on which of n1 and n2 is at the power supply potential. In the following example, assuming that the characteristics of the respective transistors are fluctuated randomly, that is, without correlation, the worst condition in which the speed of writing the information into the memory cell becomes slowest is determined.

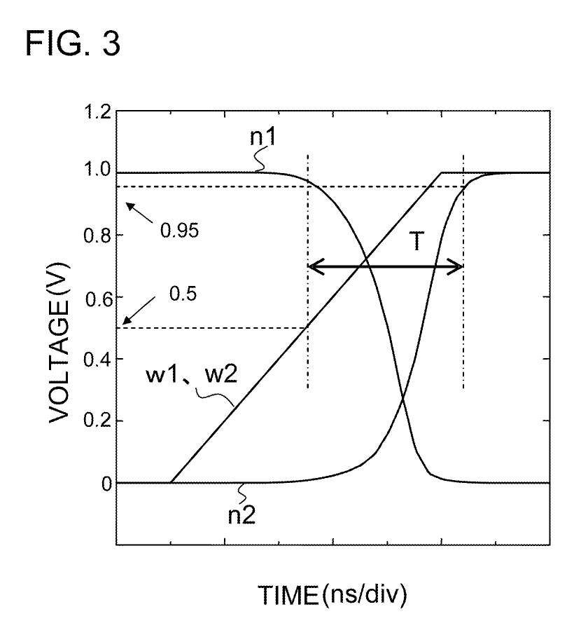

FIG. 3 shows the results of calculations by the circuit simulation of the signal waveform in case of writing the information into the SRAM of FIG. 2. In the initial state, the potential of the inner node n1 is at the power supply potential and the potential of the inner node n2 is zero. This is defined as a “1” write state. To invert this state to write “0”, the terminal b1 is set to a zero potential and the terminal b2 is set to a power supply potential. The word line potential, that is, the potential at w1 and w2, is raised from the zero potential to the power supply potential to render the access transistors a1 and a2 conductive. This lowers the potential of the inner node n1 to zero and raises the potential at the inner node n2 to the power supply potential. The time T needed for writing may be defined for this operation. For example, the time T may be defined as a time that elapses since the word line potential is half the power supply until the potential at the inner node n2 reaches 95% of the power supply voltage. In the present Example, T shown in FIG. 3 is to be the circuit performance index.

The characteristics of the respective transistors that compose the SRAM of FIG. 2 are modeled as a transistor model for circuit simulation. The model for circuit simulation states current-to-voltage characteristics of devices, such as transistors, by simple mathematical equations, and is commonly termed a compact model. Among examples of representative compact models is BSIM. One or usually a plurality of adjustable constants is included in a model equation of the compact model. The values of these constants, termed parameters, are adjusted so that the characteristics by the model equations replicate those of real devices. This adjustment operation is termed parameter extraction. If circuit simulation is performed, using the compact model, it becomes possible to calculate the waveform of FIG. 3 and the circuit performance index T.

The compact model is usually employed to model device characteristics free of fluctuations. However, the compact model may also be used for modeling the fluctuations of individual devices or the fluctuations of characteristics of a circuit that includes devices suffering from fluctuations of characteristics.

It is possible to simulate the fluctuations of the circuit characteristics of an SRAM including six transistors shown in FIG. 2 caused by the fluctuations of transistor characteristics, by regarding one or more parameters included in a transistor compact model as random variables, and the manner of the fluctuations of the variables is prescribed. As a simple practical example, only a parameter of BSIM, termed Vth0, corresponding to a transistor threshold value, is regarded as a random variable. It is assumed that the characteristics of the six transistors of the SRAM are fluctuated independently of one another. Hence, Vth0 of each of the transistors d1, d2, a1, a2, p1 and p2, referred to below as Vth0_{—}1, Vth0_{—}2, Vth0_{—}3, Vth0_{—}4, Vth0_{—}5 and Vth0_{—}6, respectively, are all regarded as independent random variables. It is assumed, for example, that these six random variables are distributed without correlation according to normal distributions of a preset median value and a preset standard deviation. The preset values of the standard deviation are set to proper values so that the simulated device characteristics by the compact model will be replications of the fluctuations of the corresponding real device characteristics. For example, the standard deviation of Vth0 can be set to be equal to the measured value of the standard deviation of the transistor's threshold value.

Thus, by regarding any one or more of the parameters in the compact model as random variables and by prescribing the manner of distribution thereof, it becomes possible to model the fluctuations of the circuit performance index. Since the circuit performance index may be calculated by circuit simulation, the circuit performance index becomes a function of the parameters of the compact model. Hence, if the manner of fluctuations of the parameters, regarded as the random variables, is prescribed, the manner of fluctuations of the circuit performance index is also prescribed via the function.

To correctly simulate a real circuit based on such a model, it is necessary to prescribe the manner of parameter fluctuations so that the manner of fluctuations of the device characteristics by the compact model will be correct replication of that of real device characteristics. If the manner of parameter fluctuations has properly been prescribed, the manner of fluctuations of the circuit performance index, as calculated by the circuit simulation, will simulate the real circuit index fluctuations.

In the above Example, a model that simulates the circuit performance index and fluctuations thereof is prescribed by prescribing a compact model and the manner of fluctuations of one or more parameters in the compact model that are regarded as random variables. The model function is calculated by circuit simulation that uses a compact model. The performance index calculation unit 112 is designed and constructed to perform circuit simulation based on the above prescription and the compact model.

In general, the circuit performance index and the model for the manner of fluctuations thereof may be represented by the following equation:

X=f(x1, x2, . . . ) (1)

where X denotes the circuit performance index and {x1, x2, . . . } denote parameters that are regarded as random variables, while f denotes a function that interrelates the two (herein termed a ‘model function’), specifically a function prescribed by a preset calculation means that calculates X. For each of the random variables, the manner of fluctuations (distribution functions and correlation among the variables) is prescribed. In the above example, {Vth0_{—}1, Vth0_{—}2, . . . } are the random variables {x1, x2, . . . }. The model function f is calculated by circuit simulation which is based on the compact model.

Meanwhile, even if the circuit simulation is used, it is not mandatory that {x1, x2, . . . } are parameters per se of the compact model. That is, let a set of parameters be {p1, p2, . . . }. The set of parameters may be represented as a function of a set of other parameters {x1, x2, . . . }, such as by

p1=g1(x1, x2, . . . ), p2=g2(x1, x2, . . . ), (2)

the manner of fluctuations of the random variables {x1, x2, . . . } being prescribed, and further the performance index X being represented as a function of {p1, p2, . . . }, as indicated by the following equation:

X=h(p1, p2, . . . }. (3)

Equations (2) and (3), combined together, reduce to equation (1). For example, {p1, p2, . . . } may be parameters of a compact model, the function h being calculated by circuit simulation, and equation (2) being calculated by some other suitable means. By transformation of parameters, indicated by the above equation (2), the degree of freedom in the manner of expression for fluctuations may be increased, thus improving the accuracy of the fluctuation model. In addition, with the transformation of parameters of equation (2), the random variables {x1, x2, . . . } may be transformed into variables convenient for calculations. For example, if the random variable x1 is defined as

p1=(standard deviation of p1)·{x1+(expected value of p1)} (4)

the expected value of x1 is 0 and the standard deviation is 1, which is convenient for numerical calculations.

When {p1, p2, . . . } are fluctuated with correlation to one another, it is preferred to express {p1, p2, . . . } as a function of mutually non-correlated random variables {x1, x2, . . . } by using a proper matrix transform equation

$$( \begin{matrix}{p}_{1} \\ {p}_{2} \\ ⋮ \\ {p}_{m}\end{matrix} ) = ( \begin{matrix}{a}_{11} & {a}_{12} & … & {a}_{1 n} \\ {a}_{21} & {a}_{22} & … & {a}_{2 n} \\ ⋮ & ⋮ & ⋱ & ⋮ \\ {a}_{m 1} & {a}_{m 2} & … & {a}_{mn}\end{matrix} ) ( \begin{matrix}{x}_{1} \\ {x}_{2} \\ ⋮ \\ {x}_{n}\end{matrix} ) \qquad ( 5 )$$

as transformation of variables of equation (2). If a method of principal component analysis, widely known as a technique for multivariate analyses, is used, the transform matrix of equation (5) may be determined so that {p1, p2, . . . } will have preset correlation.

In the above instance of the SRAM, {Vth0_{—}1, Vth0_{—}2, . . . } are regarded as being non-correlated with one another. Thus, if these are directly chosen as {x1, x2, . . . }, {x1, x2, . . . } are non-corelated random variables. There are, however, cases where parameters of the compact model are needed to be correlated with one another. Even in these cases, {x1, x2, . . . } may be random variables that are not correlated with one another. Though equation (5) does not have to be a square matrix, ordinarily, n should be equal to or less than m.

If {p1, p2, . . . } are eliminated from equations (2) and (3), the result is equation (1). Hence, equation (1) is a general equation that includes the cases represented by equations (2) and (3). The present exemplary embodiment presumes that the circuit performance index has been modeled in the form of equation (1).

The model function f in equation (1) may be prescribed based on a compact model and on circuit simulation, as in the example described above. The model function may be prescribed by any suitable means provided that it may be used as the function of the random variables {x1, x2, . . . } to calculate the circuit performance index X. The model function may also be prescribed by an analytic model equation simpler than the compact model, a simulation means, such as device simulation, implementing a model that simulates more detailed physics than the compact model, or by an approximation, such as a response surface function as later described. Hence, the form of expression for f may be one or more explicit function(s), one or more implicit function(s) or optional combinations thereof. The parameters {x1, x2, . . . } are not limited to parameters of the compact model or parameters by the above variable transformation. That is, the parameters may be physical quantities, such as device size or concentration of impurities, conditions of the manufacturing process, such as temperature or heating time, electrical characteristic values, such as threshold values of MOSFETs or any incidental parameters that quantitatively express the fluctuations.

Since the transformations of equations (4) and (5) may be combined together, the expected value and the standard deviation of all variables contained in the random variables {x1, x2, . . . } may be set to zero and unity, respectively, and the random variables {x1, x2, . . . } may also be non-correlated with one another. Thus, if discussions are limited to a case where the expected value and the standard deviation of all the random variables {x1, x2, . . . } are zero and unity, respectively and the variables are non-correlated with one another, there is no fear of loss of generality. The random variables {x1, x2, . . . } that satisfy these conditions are termed ‘normalized random variables’.

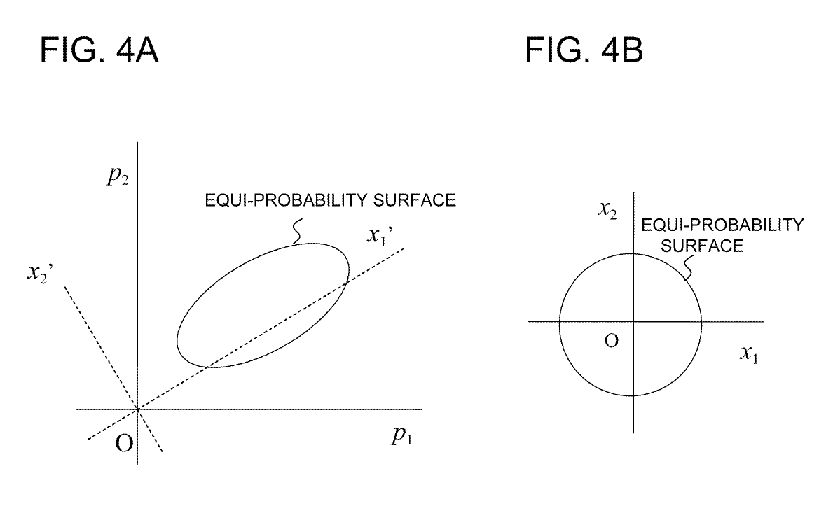

If natural phenomena are modeled by equation (3), the parameters {p1, p2, . . . } may, in many cases, be approximated by normal distributions. However, the parameters {p1, p2, . . . } may be correlated with one another and the magnitude of the fluctuations thereof (standard deviation) is not equal. Let us consider a probability density function Q(p1, p2, . . . ) which expresses the probability of occurrence of a specified combination of values of the parameters {p1, p2, . . . }. Further, if a surface of equal probability (termed “equi-probability surface”), on which the function Q assumes a specified value, is considered, such surface is ellipse as shown in FIG. 4A. In the case of a higher dimension, such surface is a hyper-ellipsoidal surface. It is observed that FIGS. 4A and 4B show cases for two dimensions, that is, a case where the number of parameters {p1, p2, . . . } is two, only for ease of drawing. In the following description, however, the cases for higher dimensions are included. For example, the number of the dimensions of the parameter space in the case of the SRAM, as set forth above, is six.

If, in FIG. 4A, the coordinate axes are rotated from the solid line positions to the broken line positions, the coordinate axes may be made parallel to the long and short axes of the ellipsoid [ellipse]. The operation of rotation may be implemented by equation (5) and specified values of the matrix elements of equation (5) may be determined by principal component analysis. If, in addition, the coordinate scale transform and translation are performed in accordance with equation (4), the surface of the equal probability becomes a circle with the center at the point of origin (a hyper-spherical surface in the general case of multiple dimensions) as shown in FIG. 4B. In this state, the expected value and the standard deviation of the random variables {x1, x2, . . . } are 0 and 1, respectively, with the random variables being non-correlated with one another. Also, the random variables {x1, x2, . . . } may still be approximated by the normal distribution. At this time, the performance index, which is of interest, is given by equation (1).

The worst condition is now described in detail. Taking the above SRAM as an example, the worst value of the performance index T prescribes the operation of the peripheral circuit that writes data into the SRAM. The peripheral circuit has to be designed so that it continues the write operation for at least the worst value of time T before moving on to the next operation, to ensure correct data writing. However, the circuit does not necessarily perform a regular operation after waiting for a certain time duration. The reason is that the performance index T is fluctuated stochastically, such that, no matter how long the waiting time is, the probability for T to be longer than such waiting time is not zero insofar as the waiting time is of a finite duration.

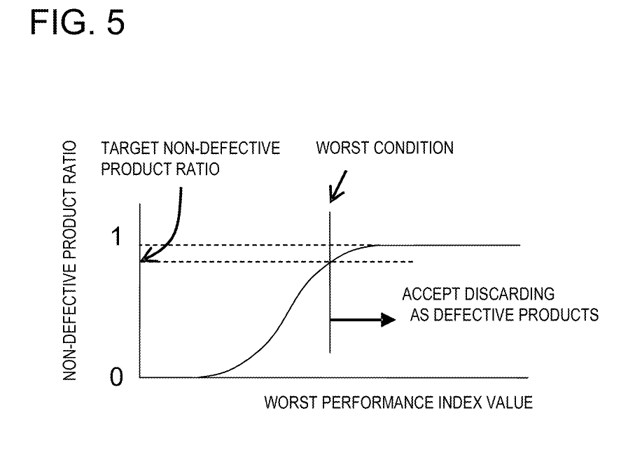

FIG. 5 shows the relationship between the worst performance index and the good product ratio.

Here, let us assume a case where, like the case of T above, a greater performance index value corresponds to worse performance. As the standard for the worst performance is loosened (i.e. worse performance is tolerated), the good product ratio approaches unity (i.e. the number of defective products will decrease). If conversely a stricter standard for the worst performance index is demanded, the good product ratio will decrease. In the above Example, if an SRAM cell is specified, the relationship as shown in FIG. 5 is determined.

It is necessary for a designer to do designing to provide for a sufficiently long waiting time for the peripheral circuit in order to acquire a desired good product ratio. However, the longer the waiting time of the peripheral circuit is, the lower becomes the performance. Hence, the waiting time cannot be needlessly prolonged. Therefore, the designer must comprehend the worst performance index value that should be tolerated, to achieve a good product ratio that is desired. The condition under which this worst performance index value is realized is the worst condition according to the present invention.

It is thus desirable to determine the worst condition as a function of the desired good product ratio. The present invention contemplates responding to this demand from the designing perspective for determining the worst condition in a manner as described above.

Among the typical applications of the worst condition thus determined, there is simulation for verification. That is, the worst condition may be used for verifying whether or not a circuit of interest, such as SRAM cell, combined with another circuit, such as SRAM write circuit, will be in normal operation while achieving a desired yield. To this end, the worst condition for the circuit of interest is comprehended, the state of the circuit is set to such a worst condition, and simulation of the circuit combined with the other circuit is carried out. If the circuit combined is in regular operation, it is confirmed that a circuit design is achieved which ensures regular operation while keeping with the desired good product ratio, assuming the existence of the fluctuations.

In the verification of large-sized circuit, it is difficult in many cases to simulate the entire circuit at once. It is therefore desirable to verify the circuits by modules, as described above.

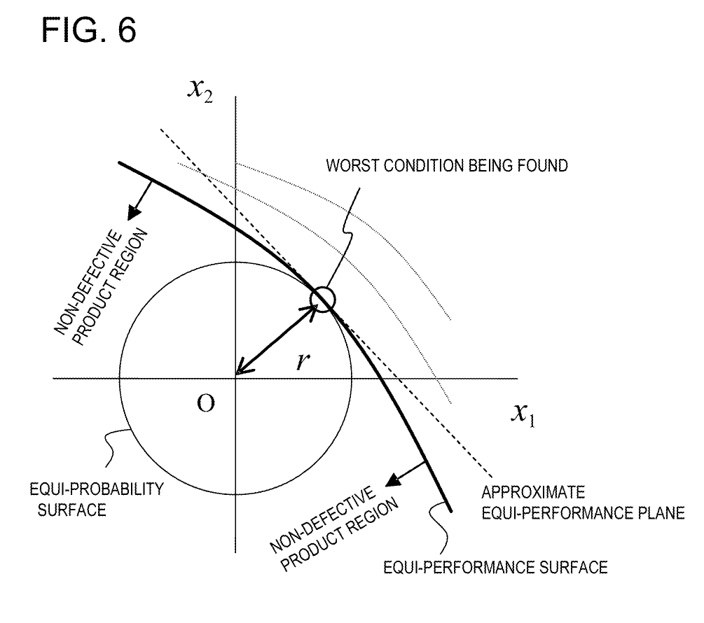

The relationship between the good product ratio, shown in FIG. 5, and the normalized random variables {x1, x2, . . . }, is now described with reference to FIG. 6.

In FIG. 6, as in FIGS. 4A and 4B, the case for two dimensions {x1, x2} is shown. Let us now consider a probability density function P{x1, x2, . . . }, showing the probability of occurrences of specified combinations of the values of random variables {x1, x2, . . . }. The probability density function P may usually be approximated by a multi-dimensional normal distribution function. A set of points for which the performance index value X given by equation (1) assume a specified value give an equi-performance surface in the space defined (spanned) by {x1, x2, . . . }. In the two-dimensional case shown in FIG. 6, the equi-performance surface reduces to a contour line. The good product ratio of FIG. 5 may be obtained by integrating the probability density function P(x1, x2, . . . ) over the entire half space of a better performance index. This half space is obtained by division of the above space along the equi-performance surface corresponding to a certain performance index value.

The problem of determining the worst condition reduces to a problem of determining, given a preset good product ratio, the equi-performance surface corresponding to the good product ratio, or coordinate values {x1, x2, . . . } for at least one point on the equi-performance surface. Once a set of the coordinate values {x1, x2, . . . }, representing the worst condition, is found, the designer may find the set of the parameters of the compact model corresponding thereto, via equation (2), and use the set of the parameters to perform circuit simulation. If a circuit, such as the peripheral circuit of an SRAM, is in regular operation by the circuit simulation under the worst condition, it can be guaranteed that the designed circuit will be in regular operation while achieving desired good product ratio.

To solve the above problem, using a computer, the following steps may be used. That is, a trial value is presupposed as a performance index value and the above probability density function P is integrated to find the good product ratio. If the good product ratio obtained is about equal to a desired value, the trial value is adopted as the worst performance index value to be found. If the difference between the good product ratio and the desired value is outside a preset allowable range, another trial value is again selected. The above-described process steps are iterated. To sequentially update the trial value in the above-described iterative calculations, it is sufficient to use a known numerical analytic method, such as bisection method. By so doing, it is possible to determine the worst performance index value.

It is then sufficient to search and find out, by known solution-finding methods, the set of coordinate values {x1, x2, . . . } for which equation (1) coincides with the worst performance index values obtained. This direct method is useful if the number of the parameters (dimensions) is small. However, if the number of parameters is increased, the computational volume needed to perform numerical integration of the probability density function P increases, and hence the method is not efficient. With the above SRAM, taken as an example, the number of parameters is 6 so that six-dimensional numerical integration is needed. If 100 division mesh is used per dimension, it is necessary to compute the probability density function P(x1, x2, . . . ) 10¹² times to calculate the good product ratio only once. Thus, if iterative calculations are carried out by, for example, the bisection method to find out the performance index value which will yield a desired good product ratio, exorbitant computational time is needed. On the other hand, the computational time increases exponentially with increase in the number of dimensions, that is, parameters, and hence the computation cannot be finished within a practically acceptable computational time. In addition, since the good product ratio to be computed is usually extremely close to unity (1), an error due to information dropout in numerical integration also becomes a problem.

A method for approximate solution to find the worst condition in such a manner as to avoid the above difficulties is now described. The integration over a multi-dimensional space, divided by a strict equi-performance surface, is in need of voluminous computational resources. Hence, the curved equi-performance surface of FIG. 6 is approximated by a plane shown by the broken line. If the probability density function P(x1, x2, . . . ) is a multi-dimensional normal distribution, an analytic expression has been known as regards the integration over one space divided by this approximate equi-performance plane. Thus, the integration, that is, the good product ratio, is given by the following cumulative normal distribution function

$$Φ ( r ) = {\int }_{- ∞}^{r} \frac{1}{\sqrt{2 π}} exp ( - {t}^{2} / 2 ) d t \qquad ( 6 )$$

where parameters {x1, x2, . . . } are assumed to be normalized, and r is the distance from the point of origin O to the approximated equi-performance plane. Thus, if r corresponding to a desired good product ratio is found by solving equation (6), and a point of contact of the spherical surface with the radius r (i.e. equi-probability surface) with an equi-performance surface can be found, the hyper-plane contacting with the equi-performance surface at this point is no other than the aforementioned approximated equi-performance plane. The point, that is, the contact point, is to be the approximately determined worst condition.

This worst condition may be determined by searching for a point corresponding to the maximum or minimum of (or, a point that maximizes or minimizes) the performance index X on the spherical surface of the radius r. The reason is that the performance index becomes worst at the point on the spherical surface of the radius r that contacts with (is tangent to) an equi-performance surface. The performance index should be maximized if a larger index value stands for a worse performance, and minimized if a smaller index value stands for a worse performance. The point thus found by search stands for the condition of the largest probability of occurrence among a set of worst conditions (set of points on the equi-performance surface corresponding to the worst circuit performance index).

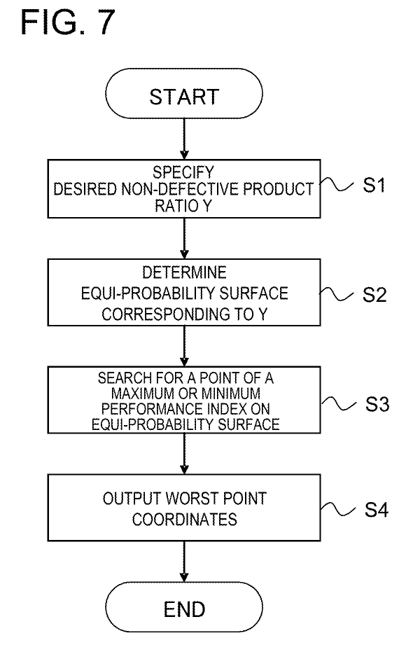

FIG. 7 depicts a flowchart for illustrating the above-described method for determining the worst condition. Initially, a desired good product ratio Y is determined (step S1). The good product ratio Y needs to be properly selected depending on the number of circuits of interest loaded on an integrated circuit (IC). If only one circuit of interest is loaded in an IC, the yield of the IC is not appreciably decreased even if the good product ratio Y is low, for example, if the defective product ratio 1−Y is 1%. However, if larger numbers of circuits (SRAM cells) are loaded, as in the case of the SRAM, the good product ratio Y needs to be of a value extremely proximate to unity (1), for example, defective product ratio 1−Y be 0.1 ppm, in order for the yield of the SRAM in its entirety to approach unity (1). It is observed that the yield of the SRAM in its entirety is given by multiplying the good product ratio Y for each cell n times, where n is the number of cells.

The radius r is then calculated by equation (6) (step S2). This calculation may be made relatively readily. The radius r is herein termed a radius of equal probability. According to the present invention, the desired good product ratio may be specified by the value of the good product ratio itself. However, it may also be specified by the radius of equal probability r.

The good product ratio Y is set at a value slightly less than unity (1). That is, the defective product ratio (=1−Y) is selected to be of a sufficiently small value. The reason why Y is selected to be not equal to unity (1) is that random fluctuations are approximated by normal distributions, whose skirt extends to an infinite region. Thus, if Y is to be set to unity (1), an infinite designing margin is needed, such that r in equation (6) needs to be infinite, thus practically disabling the designing.

Then, on the equi-probability surface, with the radius r, in a normalized parameter space, a point for which the performance index assumes a worst value is searched for (step S3). This problem is widely studied in mathematics as a non-linear optimization problem with a constraint condition, such that a variety of analytic methods have become known. Here, the function for optimization, that is, the objective function, is a function f in equation (1). The constraint condition is that the parameters {x1, x2, . . . } are on the spherical surface of the radius r set forth above. Meanwhile, searching for the performance index on the spherical surface of equal probability of the normalized parameter space (FIG. 4B) is equivalent to searching for the performance index on the corresponding ellipsoidal surface of equal probability in the non-normalized parameter space (FIG. 4A).

Finally, the coordinates of the worst point thus found is output as the worst condition (step S4) to complete the calculations.

In the foregoing explanation, searching is assumed to be performed on the surface of equal probability. More preferably, the largest (maximum) point or the smallest (minimum) point may be searched over the entire region surrounded by the surface of equal probability. Even with this search, the same results as those obtained by searching on the surface of equal probability may be obtained as long as the worst point is on the surface of equal probability. However, there is a possibility that the worst point is not on the surface of equal probability of interest, but is in an inner part surrounded by the surface of equal probability. Such situation may arise in case the performance index abruptly changes with the parameters. Even in such cases, the worst condition may correctly be determined by conducting the search for the inside of the surface of equal probability as well. However, if such results have been obtained, it is indicated that the performance index abruptly changes with the parameters. There is thus a fear that approximation used by the present invention, that is, approximation of the equi-performance surface by the approximate equi-performance plane, may be lowered in accuracy. Thus, if the worst point has been found in the inner side of the equi-probability surface, it is preferred to conduct a detailed examination as to whether or not the accuracy of the approximation used in the present invention is sufficient. Thus, in carrying out the present invention, it is preferred to provide a function of reporting that the worst point is in the inner side of the equi-probability surface if such is the case.

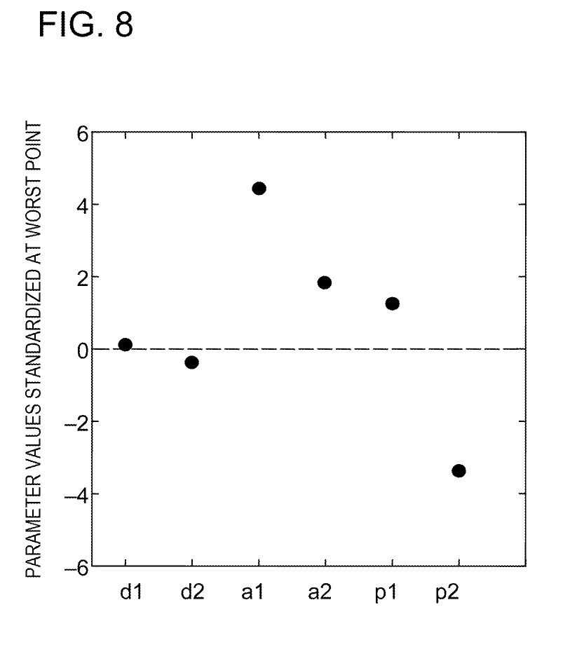

FIG. 8 shows an example of the results of calculations of the worst condition of the time T needed in writing data in an SRAM by the above-described method. The simulated annealing method has been used as a technique for non-linear optimization. The normalized parameter values are Vth0_{—}1 to Vth_{—}6 each divided by the standard deviations (all assumed to be 30 mV). That is, the values correspond to x1 to x6 normalized as by equation (4). Since Vth0_{—}1 to Vth_{—}6 are assumed to be non-correlated with one another, the coordinates are not rotated. The radius r is set as r=6 (corresponding to the defective product ratio=1−good product ratio=0.001 ppm). From these results, it has been found that the state in which the six transistors, namely the transistors d1, d2, a1, a2, p1 and p2, have threshold values varied by +0.12×30 mV, −0.37×30 mV, +4.4×30 mV, +1.8×30 mV, +1.2×30 mV and −3.4×30 mV, with respect to median values, respectively, represents the worst condition to be taken into consideration. If an SRAM cell, whose characteristics have been transformed in accordance with these values, is combined with a peripheral circuit for data write, and the combined circuit has been confirmed to be in regular operation by circuit simulation, it can be verified that there has now been provided a circuit which is in correct operation securing a desired yield.

In searching for the worst condition, it is necessary to iteratively calculate the performance index while parameters given by equation (1) are varied. To calculate the performance index, circuit simulation may be used. However, to further expedite the search, the response surface method may be used.

The response surface approximates an arbitrary relationship expressible by equation (1) by a simple function (response surface function). It is the response surface method that uses this response surface. If the calculations of equation (1) are time-consuming, equation (1) may be approximated by a simpler equation to provide for shorter computational time. With the 6-variable SRAM, taken up herein, for instance, it is preferred to approximate equation (1) by the following quadratic polynomial:

$$X = {b}_{00} + {b}_{01} {x}_{1} + {b}_{02} {x}_{2} + {b}_{03} {x}_{3} + {b}_{04} {x}_{4} + {b}_{05} {x}_{5} + {b}_{06} {x}_{6} + {b}_{11} {x}_{1}^{2} + {b}_{12} {x}_{1} {x}_{2} + {b}_{13} {x}_{1} {x}_{3} + {b}_{14} {x}_{1} {x}_{4} + {b}_{15} {x}_{1} {x}_{5} + {b}_{16} {x}_{1} {x}_{6} + {b}_{22} {x}_{2}^{2} + {b}_{23} {x}_{2} {x}_{3} + {b}_{24} {x}_{2} {x}_{4} + {b}_{25} {x}_{2} {x}_{5} + {b}_{26} {x}_{2} {x}_{6} + {b}_{33} {x}_{3}^{2} + {b}_{34} {x}_{3} {x}_{4} + {b}_{35} {x}_{3} {x}_{5} + {b}_{36} {x}_{3} {x}_{6} + {b}_{44} {x}_{4}^{2} + {b}_{45} {x}_{4} {x}_{5} + {b}_{46} {x}_{4} {x}_{6} + {b}_{55} {x}_{5}^{2} + {b}_{56} {x}_{5} {x}_{6} + {b}_{66} {x}_{6}^{2} . \qquad ( 7 )$$

It is noted that the coefficients b00, b01, . . . , b66 are properly selected so that the approximated equation (7) will optimally approximate equation (1) as an object of approximation. To this end, the values to be assumed by equation (1) in case the parameters {x1, x2, . . . } are varied are checked. This operation is termed ‘experiment’. To calculate equation (1), circuit simulation, for example, is used. This yields values of X corresponding to combinations of a wide variety of the values of {x1, x2, . . . , x6}. The coefficients b00, b01, . . . , b66 in equation (7) are determined so that the results of the experiment will be approximately reproduced by equation (7). By taking a sufficiently large number of the points of experiment, it is possible to determine these coefficients readily by linear multiple regression analysis. Once the response surface function, such as equation (7), is determined, equation (7) may be used in place of equation (1). If circuit simulation is needed for calculating equation (1), and much computational time is needed, it is possible to use the response surface function of equation (7) to expedite the search for the worst condition. Other functions suitable for approximation may also be used in place of the quadratic polynomial. However, it is necessary to confirm that the response surface function is a sufficiently correct expression of equation (1).

With the above example, such a model that simulates the circuit performance index and fluctuations thereof has been prescribed by prescribing the response surface function, and the state of fluctuations of one or more of the parameters of the response surface function regarded as random variables. The model function is no other than the response surface function. The performance index calculation unit 112 is designed and formulated to calculate the response surface function. In the case of the above Example, all of the six parameters are regarded as random variables. Meanwhile, it is allowable that parameters which are not random variables are included from time to time in the response surface function.

According to the present invention, a solution may be found simply by evaluating the performance index values, given by equation (1), on the equi-probability surface or within the region surrounded by the equi-probability surface. It is therefore unnecessary to apply linear approximation or sensitivity analysis to equation (1). Hence, there may be obtained a merit that the error is not increased even though equation (1) is non-linear.

Among the factors of errors in the method for determining the worst condition in the present invention, there is a fact that a region of integration differs from a region to be truly integrated by an area surrounded between the equi-performance surface and the approximate equi-performance plane in FIG. 6. However, the further away the probability density function P{x1, x2, . . . } from the point of origin, the more rapidly the probability density function is attenuated. Hence, an error ascribable to this difference is negligibly small. To confirm this, the good product ratio by the Monte Carlo simulation was compared to that calculated by the approximate equi-performance surface according to the present invention. As for the Monte Carlo simulation, the good product ratio as calculated by the true equi-performance surface can be determined by a sufficiently large number of times of calculations. With the example of the SRAM write time, set forth above, the error caused was about 10%. This error is negligibly small in consideration that the good product ratio varies exponentially with respect to the parameters.

In general, different worst conditions are obtained from one performance index of interest to another. If a number of different constraint conditions need to be taken into account, it is necessary to find the worst condition for each of the performance index of interest. In such cases, it is sufficient to apply the method of determining the worst conditions according to the present invention multiple times. In the case of the above SRAM, the worst condition needs to be considered not only for the write time but also for the readout time. In the case of a logic circuit, too small delay may also be of a problem. In such cases, it is necessary to search for a condition for the smallest delay in addition to a condition for the largest delay. That is, there are many cases where there exist a plurality of the worst conditions that need to be taken into consideration. It is then sufficient to apply the method for determining the worst condition according to the present invention to each of the worst conditions.

The present invention may also be used in combination with the method disclosed in Non-Patent Document 1. That is, the worst condition obtained by the present invention may also be applied not only to simulation for verification but also as a constraint condition for design optimization.

### INDUSTRIAL APPLICABILITY

The system, method and the program for determining the worst condition according to the present invention may be applied to the designing of integrated circuits, such as memory cells, analog circuits or digital circuits.

It will be appreciated that the particular exemplary embodiments or examples may be modified or adjusted within the gamut of the entire disclosure of the present invention, inclusive of claims, based on the fundamental technical concept of the invention. Further, variegated combinations or selections of the elements disclosed herein may be made within the scope of the claims.

What is claimed is:

1. A system for determining a worst condition,
wherein, in a model for which one or more parameters included in a model function that simulates a circuit performance index are random variable(s) to simulate the circuit performance index and fluctuations thereof, said parameter(s) for which said circuit performance index assumes a maximum or minimum value that is to be assumed from the viewpoint of designing is determined as the worst condition;
said system comprising:
a worst condition search unit that searches for a point, which maximizes or minimizes said circuit performance index, on an equi-probability surface or in a region surrounded by said equi-probability surface, in a space spanned by said parameter(s); said equi-probability surface corresponding to a preset good product ratio; said point thus obtained being determined as the worst condition.

2. The system for determining a worst condition according to claim 1, further comprising:
an inputting unit that inputs information that specifies said good product ratio used in said worst condition search unit;
a performance index calculation unit that calculates said circuit performance index based on said model function; and
an outputting unit that outputs said worst condition as found by said worst condition search unit.

3. The system for determining a worst condition according to claim 1, wherein
said equi-probability surface is any one of a hyper-ellipsoidal surface, an ellipsoidal surface and an arc of ellipse.

4. The system for determining a worst condition according to claim 2, wherein
said outputting unit is adapted to further output that said worst condition as found by said worst condition search unit existed inside of said equi-probability surface.

5. The system for determining a worst condition according to claim 1, or wherein
said model function is calculated by circuit simulation.

6. The system for determining a worst condition according to claim 1, wherein
said model function is a response surface function.

7. A system for determining a worst condition,
wherein, given a model function of a performance index and a probability density function for a set of variable(s) of said model function, a point, on an equi-value surface of said model function, having the highest occurrence probability is determined as the worst condition, on condition that said probability density function integrated over a subdomain of definition, corresponding to better performance index, bounded by said equi-value surface of said model function, is equal to a preset value;
said system comprising:
a worst condition search unit that determines an equi-probability surface that is to be tangent to said equi-value surface; said worst condition search unit searching for a point, which maximizes or minimizes said performance index, on said equi-probability surface or within a region surrounded by said equi-probability surface; said worst condition search unit determining said point as said worst condition.

8. A method for determining a worst condition, wherein, in a model, for which one or more parameters included in a model function that simulates a circuit performance index are random variable(s) to simulate said circuit performance index and fluctuations thereof, said parameter(s) for which said circuit performance index assumes a maximum or minimum value that is to be assumed from the viewpoint of designing is determined as the worst condition;
determining an equi-probability surface corresponding to a preset good product ratio in a space spanned by said parameter(s); and
searching for a point, which maximizes or minimizes said performance index, on said equi-probability surface or within a region surrounded by said equi-probability surface; said point being determined as the worst condition.

9. A program that causes a computer to perform a processing wherein, in a model for which one or more parameters included in a model function that simulates a circuit performance index are random variable(s) to simulate said circuit performance index and fluctuations thereof, said parameter(s) for which said circuit performance index assumes a maximum or minimum value that is to be assumed from the viewpoint of designing is determined as the worst condition;
said program causing the computer to perform:
determining an equi-probability surface corresponding to a preset good product ratio in a space spanned by said parameter(s); and
searching for a point, which maximizes or minimizes said performance index, on said equi-probability surface or within a region surrounded by said equi-probability surface; said point being determined as the worst condition.
